(19) United States
(12) Patent Application Publication
(10) Pub. No.: US 2026/0002857 A1
(43) Pub. Date: Jan. 1, 2026

(54) METHOD AND SYSTEM FOR ANALYZING PARTICLE SIZE OF FLY ASH

(71) Applicant: North United (Bayannur) Clean Energy Power Co., Ltd., Bayannur City (CN)

(72) Inventors: Chang Li, Bayannur City (CN); Zhihong Xie, Bayannur City (CN); Yu Wang, Bayannur City (CN); Yongli Tang, Bayannur City (CN); Chenyuan Lv, Bayannur City (CN); Jingyu Zhang, Bayannur City (CN)

(73) Assignee: North United (Bayannur) Clean Energy Power Co., Ltd., Bayannur City, NM (CN)

(21) Appl. No.: 19/317,742

(22) Filed: Sep. 3, 2025

(30) Foreign Application Priority Data
Sep. 5, 2024 (CN) CN202411242206.5

(51) Int. Cl. G01N 15/0205; G01N 15/0227

(52) U.S. Cl. CPC G01N 15/0211; G01N 15/0227

(57) ABSTRACT

A method and a system for analyzing the particle size of fly ash are provided. The method includes performing drying treatment on the sample to ensure that the water content is lower than 0.5%; uniformly dispersing the particles by using ultrasonic wave or airflow dispersion technology; measuring the particle size by laser particle size analyzer to generate cumulative distribution curve; calculating the median particle size and specific surface area by cumulative distribution curve. The system of the disclosure has an automatic operation function, and may automatically complete sample treatment, particle size measurement, data analysis and result output. This method improves the accuracy of measurement and data processing, and is suitable for efficient analysis of a large number of samples, which has a wide industrial application prospect.

### CROSS-REFERENCE TO RELATED APPLICATIONS

This application claims priority of Chinese Patent Application No. 202411242206.5, filed on Sep. 5, 2024, the content of which is hereby incorporated by reference.

### TECHNICAL FIELD

The disclosure relates to the technical field of civil engineering, and in particular to a method and a system for analyzing particle size of fly ash.

### BACKGROUND

Fly ash is a fine-grained waste discharged from coal-fired power plants, which is mainly composed of mineral residues that are not completely burned during coal combustion. Because of the fine particles and rich chemical composition, fly ash has a wide application prospect in building materials, road paving, environmental protection engineering and other fields. However, the physical and chemical characteristics of fly ash, such as particle size distribution and specific surface area, directly affect application effect in these fields. Therefore, it is of great significance to accurately measure and analyze the particle size distribution and specific surface area of fly ash for improving the utilization efficiency of fly ash.

At present, the particle size analysis methods of fly ash mainly include screening method, sedimentation method, laser particle size analysis method and image analysis method. Where, the screening method is widely used in the particle size analysis of coarse-grained powder because of simple operation, but for fine-grained material such as fly ash, the accuracy of the screening method is low and it is difficult to accurately measure the particle size distribution. Sedimentation method calculates the particle size by the settling velocity of particles in liquid. Although it may be applied to the analysis of finer particles, it is limited by the operating environment and liquid medium, and the stability and reproducibility of the test results are poor. Laser particle size analysis method measures particle size distribution of particles by laser scattering principle, which has high accuracy and repeatability and has become the mainstream method of fly ash particle size analysis. However, this method depends on expensive device, which requires high pretreatment of samples, and the measurement results are easily affected by particle agglomeration and poor dispersion of samples.

Under the above background, how to effectively treat and disperse fly ash samples, accurately measure particle size distribution and calculate specific surface area has become an urgent problem in the prior art. In order to improve the accuracy and efficiency of fly ash particle size analysis, an improved method and system are needed, which may accurately measure and calculate the particle size distribution and specific surface area of fly ash on the basis of ensuring the uniform dispersion of samples.

The disclosure provides a method and a system for analyzing the particle size of fly ash. By fully drying and dispersing the fly ash sample, the particle size distribution of the sample may be accurately measured by combining laser particle size analysis and image analysis technology. At the same time, the accuracy of the analysis and the repeatability of the results are further improved by using the cumulative distribution curve and the formula for calculating the specific surface area. The system provided the disclosure also has the function of automatic operation, which may realize the automatic processing, measurement and data analysis of samples, greatly improve the working efficiency and reduce the possible errors caused by manual operation.

Compared with the traditional technology, the method for analyzing the particle size of fly ash of the disclosure has achieved remarkable improvement in the following aspects.

The sample treatment is more optimized: by strictly controlling the drying conditions and dispersion treatment parameters, the particle size distribution measurement of fly ash samples is ensured not to be affected by particle agglomeration and water residue, thus improving the accuracy of measurement.

The data processing is more accurate: the median particle size and specific surface area are calculated by using the cumulative distribution curve, and the number of particles in the particle size interval is determined by image analysis, which enhances the reliability of the measurement results.

The automation level of the system is improved: the system of the disclosure integrates the whole process automation operation of sample processing, particle size measurement, data analysis and result output, and may treat a large number of samples, thus significantly improving the analysis efficiency and data consistency.

The disclosure is not only suitable for the particle size analysis of conventional fly ash, but also widely used for the particle size determination of other fine-grained substances, providing more reliable and efficient technical support for industrial production and scientific research. By accurately measuring the particle size distribution and specific surface area of fly ash, the disclosure will be helpful to further expand the application field of fly ash and enhance resource utilization value.

### SUMMARY

The disclosure aims at overcoming the shortcomings of the prior art, and provides a method and a system for analyzing the particle size of fly ash in order to solve the problems raised in the background technology.

In order to achieve the above purpose, the disclosure provides the following technical scheme: a method for analyzing the particle size of fly ash is provided, and includes the following steps:
sample preparation: collecting and evenly mixing a fly ash sample, and performing drying treatment on the sample, and enabling water content lower than 0.5%;
sample dispersion: performing dispersion treatment on a dried fly ash sample by using an ultrasonic disperser or an airflow disperser, and enabling particles to be uniformly dispersed in measuring medium to avoid particle agglomeration;
particle size measurement: sending a dispersed sample into a laser particle size analyzer or an image analysis device to measure particle size distribution data of the fly ash sample;
data processing: processing data based on particle size measurement results, where the data processing includes: constructing a cumulative distribution curve, determining median particle size and calculating specific surface area;
where, the constructing a cumulative distribution curve includes: based on the particle size measurement results, calculating and accumulating volume Vᵢ of each of particle size intervals, constructing a cumulative distribution curve CDF(d) of the particle size,

$$CDF ( d ) = \frac{{\sum }_{i = 1}^{j} {V}_{i}}{{V}_{total}} ;$$

where, CDF(d) represents cumulative volume distribution at particle size d, Vᵢ represents volume of an i-th particle size interval, Vₜₒₜₐₗ is total volume of the sample, j is a number of a particle size interval currently accumulated when calculating the cumulative distribution curve, and represents accumulation from a first interval i=1 to a j-th interval;
determining median particle size: according to the cumulative distribution curve, determining particle size Dᵥ₍₅₀₎ corresponding to 50% cumulative volume distribution, that is, the particle size meeting CDF(Dᵥ₍₅₀₎)=0.5; and
outputting results: generating and outputting a particle size distribution curve, cumulative distribution data, the median particle size Dᵥ₍₅₀₎ and specific surface area S_{BET} parameters to form a complete analysis report.

As the preferred technical scheme of the disclosure, temperature of the drying treatment is controlled between 100° C. and 120° C., and drying time is 1 to 2 hours to ensure the water content of the fly ash sample being lower than 0.5%.

As the preferred technical scheme of the disclosure, working frequency of the ultrasonic disperser is 20 to 40 kHz, and dispersing time is 5 to 10 minutes; airflow speed of the airflow disperser is 1 to 2 m/s, and dispersion time is 3 to 5 minutes.

As the preferred technical scheme of the disclosure, the laser particle size analyzer is used in the particle size measurement, and measurement range is 0.1 to 1000 microns, preferably 0.5 to 500 microns, and measurement results include a particle size distribution cumulative curve and a volume distribution curve.

As the preferred technical scheme of the disclosure, the calculating specific surface area includes: calculating the specific surface area S_{BET} by using a formula

$${S}_{BET} = \frac{6}{ρ \cdot {D}_{mean}} .$$

where, S_{BET} represents the specific surface area, ρ is density of the fly ash, and Dₘₑₐₙ is average particle size calculated by the cumulative distribution curve.

As the preferred technical scheme of the disclosure, Dₘₑₐₙ is the average particle size calculated by the cumulative distribution curve:

$${D}_{mean} = \frac{{\sum }_{i = 1}^{n} {d}_{i} \cdot {n}_{i}}{{\sum }_{i = 1}^{n} {n}_{i}} ;$$

calculating the average particle size Dₘₑₐₙ of the sample, where dᵢ is particle size of an i-th particle size interval and nᵢ is a number of particles in a corresponding particle size interval.

As the preferred technical scheme of the disclosure, a report generated in the outputting results includes the particle size distribution curve, the cumulative distribution curve, the median particle size D_{v(50),} the average particle size Dₘₑₐₙ and specific surface area S_{BET} key parameters, and the report is remotely output through network or stored in a database, so as to be convenient for long-term monitoring and data comparative analysis.

A system for analyzing particle size of fly ash is also provided, and includes:

a sample treatment module, including a drying device, an ultrasonic disperser or an airflow disperser, and configured for drying and dispersing treatment fly ash sample, where the drying device adopts an oven;

a particle size measuring module, including a laser particle size analyzer or an image analysis device, and configured for measuring particle size distribution of the fly ash sample and generating particle size distribution data;

a data processing module, including special software, and configured for processing measured data, calculating median particle size Dᵥ₍₅₀₎, average particle size Dₘₑₐₙ, specific surface area S_{BET} and cumulative distribution curve CDF(d) parameters, and generating an analysis report; and

a result output module, configured for outputting and storing analysis results, supporting data storage, report generation and a remote access function.

As the preferred technical scheme of the disclosure, the system has an automatic operation function, and is capable of automatically completing whole process of sample processing, particle size measurement, data processing and result outputting, and is capable of monitoring and analyzing key parameters in the process in real time to improve accuracy and efficiency of measurement.

Compared with the prior art, the disclosure has the beneficial effects that the accuracy and stability of particle size analysis are improved: by optimizing the drying and dispersion treatment steps of the fly ash sample, the influence of water residue and particle agglomeration in the sample on the measurement result is significantly reduced.

Strictly controlled drying temperature and time are adopted to ensure that the water content of the sample is lower than 0.5%. Combined with ultrasonic dispersion or airflow dispersion technology, the particles are uniformly dispersed in the measuring medium, thus improving the accuracy of particle size distribution measurement. The method of the disclosure may provide stable and reliable particle size distribution data for both coarse-grained and fine-grained fly ash, thus effectively reducing measurement error and data fluctuation.

The accuracy and analysis depth of data processing are enhanced: the disclosure introduces an innovative algorithm of cumulative distribution curve and specific surface area calculation, which makes the calculation of median particle size Dᵥ₍₅₀₎ and specific surface area S_{BET} more accurate. In addition, the number of particles in each particle size interval is determined by image analysis method, which further improves the calculation accuracy of particle size distribution and average particle size Dₘₑₐₙ. These improvements make the analysis results of particle size distribution and specific surface area of fly ash samples more reliable, which provides strong data support for subsequent industrial applications.

The automation and high efficiency of system operation are realized: the fly ash particle size analysis system of the disclosure integrates fully automatic operation processes of sample processing, particle size measurement, data processing and result output. The system may automatically complete the analysis of a large number of samples, which significantly improves the work efficiency and ensures the consistency and repeatability of the data. In addition, the system supports the remote output and storage of data, so that the analysis results may be applied to production and scientific research in time. This highly automatic design not only reduces the error caused by manual operation, but also greatly improves the accuracy and efficiency of analysis, and is suitable for rapid analysis of various fly ash and other fine particle substances.

### BRIEF DESCRIPTION OF THE DRAWINGS

FIG. 1 is a flow chart of a method for analyzing particle size of fly ash according to the disclosure; and

FIG. 2 is a system block diagram of a system for analyzing particle size of fly ash according to the disclosure.

### DETAILED DESCRIPTION OF THE EMBODIMENTS

In the following, the technical scheme in the embodiment of the disclosure will be clearly and completely described with reference to the attached drawings in the embodiment of the disclosure. Obviously, the described embodiment is only a part of the embodiment of the disclosure, but not all of the embodiments. Based on the embodiments in the disclosure, all other embodiments obtained by ordinary skilled in the field without creative efforts belong to the scope of protection of the disclosure.

In the following, specific embodiments of the disclosure will be described in detail with reference to the attached drawings and various embodiments.

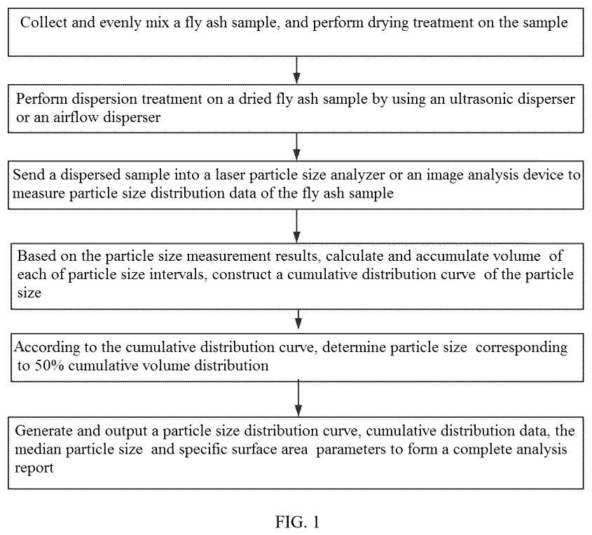

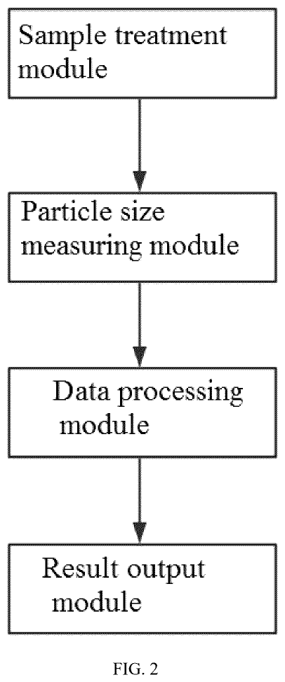

Referring to FIGS. 1 and 2, a method and a system for analyzing the particle size of fly ash are provided, which may effectively obtain important parameters such as particle size distribution and specific surface area of fly ash through accurate measurement and data processing. The application and operation of the disclosure will be described in detail with reference to a number of specific embodiments.

### Embodiment 1: Standard Fly Ash Particle Size Analysis Method

### Step 1: Sample Preparation

A fly ash sample of 200 grams is collected from a coal-fired power plant.

In order to ensure the representativeness of the sample, the sample is mixed evenly first, and then 50 grams are taken out for analysis. In order to eliminate the influence of moisture on particle size measurement, the sample is put into a vacuum drying oven and dried at 105° C. for 1.5 hours until the water content of the sample is lower than 0.5%.

### Step 2: Sample Dispersion

The dried fly ash sample is taken out and dispersed by an ultrasonic disperser.

The working frequency of the disperser is set to 35 kHz and the dispersing time to 8 minutes. In order to ensure the dispersion effect, a magnetic stirrer is used to keep the sample evenly distributed and avoid particle agglomeration in the process of dispersion.

### Step 3: Particle Size Measurement

The dispersed sample is immediately sent to a laser particle size analyzer for particle size measurement. The measuring range of the instrument is 0.1 to 1000 microns, and the particularly preferred range is 0.5 to 500 microns.

Based on the principle of laser scattering, the instrument measures and automatically generates the cumulative curve and volume distribution curve of particle size distribution.

### Step 4: Data Processing

The measured data is processed, firstly, the volume Vᵢ of each particle size interval is calculated, and the cumulative distribution curve is constructed by using the formula

$$CDF ( d ) = \frac{{\sum }_{i = 1}^{j} {V}_{i}}{{V}_{total}} .$$

Where j represents the number accumulated to the current particle size interval, Vₜₒₜₐₗ is the total volume of the sample.

The particle size Dᵥ₍₅₀₎ corresponding to 50% cumulative volume distribution is determined by the cumulative distribution curve, which met CDF(Dᵥ₍₅₀₎)=0.5.

$${S}_{BET} = \frac{6}{ρ \cdot {D}_{mean}} ,$$

where Dₘₑₐₙ is the average particle size calculated by the cumulative distribution curve, and ρ is the density of fly ash, which is usually 2.6 g/cm'.

Step 5: the analysis report generated by the result output system includes particle size distribution curve, cumulative distribution data, median particle size Dᵥ₍₅₀₎, average particle size Dₘₑₐₙ and specific surface area S_{BET}.

The report is output remotely through the network and stored in the database for further analysis and comparison.

Results and analysis: the test results show that the median particle size of the sample is 18.2 microns, the average particle size is 19.8 microns, and the specific surface area is 430 m²/kg. These data provide an important reference for evaluating the application of fly ash in concrete additives.

### Embodiment 2: Analysis of Particle Size of Fly Ash Under Different Drying Conditions

Objective: to explore the influence of different drying temperatures and time on the measurement results of fly ash particle size.

Step: three samples of the same batch of fly ash are taken, each weighing 50 g, and which are treated under different drying conditions:

sample A: dried at 105° C. for 2 hours;

sample B: dried at 120° C. for 1.5 hours;

sample C: dried at 80° C. for 3 hours.

Each sample is treated and analyzed using the same dispersion and particle size measurement procedures.

Results and analysis: the median particle size of sample A is 18.2 microns and the average particle size is 19.8 microns; the median particle size of sample B is 18.0 microns and the average particle size is 19.5 microns; the median particle size of sample C is 18.5 microns and the average particle size is 20.1 microns.

The results show that different drying temperatures and time have little effect on the particle size distribution of fly ash, but too high temperature (such as 120° C.) may lead to the agglomeration of some particles, which slightly reduces the median and average particle size. Low temperature treatment with long drying time (such as 80° C. for 3 hours) may make the particles more dispersed.

### Embodiment 3: Comparison of Particle Size Distribution of Fly Ash From Different Sources

Objective: to evaluate the differences in particle size distribution and specific surface area of fly ash samples from different power plants, so as to guide their different uses.

Step: fly ash samples are collected from three power plants (A, B, C) respectively, each sample is treated with 50 g, and analyzed according to the standard operation flow of Embodiment 1.

The sample of power plant A: the median particle size Dᵥ₍₅₀₎ is 16.5 microns, the average particle size Dₘₑₐₙ is 18.0 microns, and the specific surface area S_{BET} is 420 m²/kg.

The sample of power plant B: the median particle size Dᵥ₍₅₀₎ is 12.8 microns, the average particle size Dₘₑₐₙ is 15.2 microns, and the specific surface area SBET is 500 m²/kg.

Sample of power plant C: median particle size Dᵥ₍₅₀₎ is 20.0 microns, average particle size Dₘₑₐₙ is 21.5 microns, and specific surface area S_{BET} is 390 m²/kg.

Results and analysis: the analysis results show that there are significant differences in the particle size distribution of fly ash from different power plants. The sample from the power plant B has a small particle size and a large specific surface area, which is suitable for being used as concrete additives or adsorption materials. The sample of the power plant C has a large particle size, which may be more suitable for foundation filling or brick manufacturing.

### Embodiment 4: Automatic Test of Fly Ash Particle Size Analysis System

Objective: to test the automatic analysis ability and data stability of the system, especially when dealing with a large number of samples.

Step: fifty different batches of fly ash samples are analyzed, each sample is about 50 g. The system uses automatic sampling device to automatically complete drying, dispersion, measurement and data processing.

The processing time of each sample and the stability of the measurement results are recorded.

Results and analysis: in the automatic mode, the average processing time of each sample is 6 minutes, the standard deviation of median particle size data of all samples is less than 0.3%, and the change range of specific surface area is within 2%.

In addition, the system shows good stability and reliability in long-term operation, which is suitable for large-scale industrial applications and scientific research experiments.

### Embodiment 5: Study on Correlation Between Specific Surface Area and Application Performance of Fly Ash

Objective: to study the application performance of fly ash in concrete and adsorption materials by measuring specific surface area of fly ash.

Step: three representative fly ash samples are selected, and the particle size distribution and specific surface area are measured respectively. Then, these samples are mixed into concrete respectively, and the effects on the compressive strength of concrete are measured. At the same time, the sample is applied to the wastewater adsorption experiment to evaluate adsorption effect on heavy metal ions.

Results and analysis: the samples with large specific surface area (such as sample B, with a specific surface area of 500 m²/kg) show better reinforcement effect in concrete, which increased the compressive strength of concrete by 15%. In the adsorption experiment, the adsorption rate of the sample for heavy metal ions (such as lead ions) reaches 85%.

Samples with small specific surface area (such as sample C, with a specific surface area of 390 m²/kg) have weak concrete reinforcement effect, only increasing the compressive strength by 5%, but show better fluidity and compactness in the application of foundation fillers.

What has not been described in detail in this description belongs to the prior art known to those skilled in the art. Although the disclosure has been described in detail with reference to the foregoing embodiments, it is still possible for those skilled in the art to modify the technical schemes described in the foregoing embodiments or to replace some technical features by equivalents. Any modification, equivalent substitution, improvement, etc. made within the spirit and principle of the disclosure should be included in the protection of the disclosure.

What is claimed is:

1. A method for analyzing particle size of fly ash, comprising:
sample preparation: collecting and evenly mixing a fly ash sample, and performing drying treatment on the sample, and enabling water content lower than 0.5%;
sample dispersion: performing dispersion treatment on a dried fly ash sample by using an ultrasonic disperser or an airflow disperser, and enabling particles to be uniformly dispersed in measuring medium to avoid particle agglomeration;
particle size measurement: sending a dispersed sample into a laser particle size analyzer or an image analysis device to measure particle size distribution data of the fly ash sample;
data processing: processing data based on particle size measurement results, wherein the data processing comprises: constructing a cumulative distribution curve, determining median particle size and calculating specific surface area;
wherein, the constructing a cumulative distribution curve comprises: based on the particle size measurement results, calculating and accumulating volume Vᵢ of each of particle size intervals, constructing a cumulative distribution curve CDF(d) of the particle size,
$$CDF ( d ) = \frac{{\sum }_{i = 1}^{j} {V}_{i}}{{V}_{total}} ;$$
wherein, CDF(d) represents cumulative volume distribution at particle size d, Vᵢ represents volume of an i-th particle size interval, Vₜₒₜₐₗ is total volume of the sample, j is a number of a particle size interval currently accumulated when calculating the cumulative distribution curve, and represents accumulation from a first interval i=1 to a j-th interval;
determining median particle size: according to the cumulative distribution curve, determining particle size Dᵥ₍₅₀₎ corresponding to 50% cumulative volume distribution, that is, the particle size meeting CDF(Dᵥ₍₅₀₎)=0.5; and
outputting results: generating and outputting a particle size distribution curve, cumulative distribution data, the median particle size Dᵥ₍₅₀₎ and specific surface area S_{BET} parameters to form a complete analysis report.

2. The method for analyzing particle size of fly ash according to claim 1, wherein temperature of the drying treatment is controlled between 100° C. and 120° C., and drying time is 1 to 2 hours to ensure the water content of the fly ash sample being lower than 0.5%.

3. The method for analyzing particle size of fly ash according to claim 1, wherein working frequency of the ultrasonic disperser is 20 to 40 kHz, and dispersing time is 5 to 10 minutes; airflow speed of the airflow disperser is 1 to 2 m/s, and dispersion time is 3 to 5 minutes.

4. The method for analyzing particle size of fly ash according to claim 1, wherein the laser particle size analyzer is used in the particle size measurement, and measurement range is 0.1 to 1000 microns, preferably 0.5 to 500 microns, and measurement results comprise a particle size distribution cumulative curve and a volume distribution curve.

5. The method for analyzing particle size of fly ash according to claim 1, wherein the calculating specific surface area comprises: calculating the specific surface area S_{BET} by using a formula
$${S}_{BET} = \frac{6}{ρ \cdot {D}_{mean}} ;$$
wherein, S_{BET} represents the specific surface area, ρ is density of the fly ash, and Dₘₑₐₙ is average particle size calculated by the cumulative distribution curve.

6. The method for analyzing particle size of fly ash according to claim 5, wherein Dₘₑₐₙ is the average particle size calculated by the cumulative distribution curve:
$${D}_{mean} = \frac{{\sum }_{i = 1}^{n} {d}_{i} \cdot {n}_{i}}{{\sum }_{i = 1}^{n} {n}_{i}} ;$$
calculating the average particle size Dₘₑₐₙ of the sample, wherein dᵢ is particle size of an i-th particle size interval and nᵢ is a number of particles in a corresponding particle size interval.

7. The method for analyzing particle size of fly ash according to claim 1, wherein a report generated in the outputting results comprises the particle size distribution curve, the cumulative distribution curve, the median particle size Dᵥ₍₅₀₎, the average particle size Dₘₑₐₙ and specific surface area S_{BET} key parameters, and the report is remotely output through network or stored in a database, so as to be convenient for long-term monitoring and data comparative analysis.

8. A system for analyzing particle size of fly ash, comprising:
a sample treatment module, comprising a drying device, an ultrasonic disperser or an airflow disperser, and configured for drying and dispersing treatment fly ash sample, wherein the drying device adopts an oven;
a particle size measuring module, comprising a laser particle size analyzer or an image analysis device, and configured for measuring particle size distribution of the fly ash sample and generating particle size distribution data;
a data processing module, comprising special software, and configured for processing measured data, calculating median particle size Dᵥ₍₅₀₎, average particle size Dₘₑₐₙ, specific surface area S_{BET} and cumulative distribution curve CDF(d) parameters, and generating an analysis report; and
a result output module, configured for outputting and storing analysis results, supporting data storage, report generation and a remote access function.

9. The system for analyzing particle size of fly ash according to claim 8, wherein the system has an automatic operation function, and is capable of automatically completing whole process of sample processing, particle size measurement, data processing and result outputting, and is capable of monitoring and analyzing key parameters in the process in real time to improve accuracy and efficiency of measurement.
